(19) United States
(12) Patent Application Publication
(10) Pub. No.: US 2017/0345044 A1
(43) Pub. Date: Nov. 30, 2017

(54) PROCESS FOR REWARDING THE AUDIENCE OF A SIGNAGE DEVICE

(71) Applicant: QUIVIDI, Paris (FR)

(72) Inventors: Paolo Prandoni, Paris (FR); Olivier Duizabo, Paris (FR); Ke-Quang Nguyen-Phuc, Paris (FR)

(73) Assignee: QUIVIDI, Paris (FR)

(21) Appl. No.: 15/523,883

(22) PCT Filed: Nov. 5, 2014
(86) PCT No.: PCT/EP2014/073844

§ 371 Date: May 2, 2017

(51) Int. Cl. G06Q 30/02

(52) U.S. Cl. CPC G06Q 30/0236; G06Q 30/0269; G06Q 30/0261

(57) ABSTRACT

A process for rewarding the audience of a signage device, the process providing for
detecting an interest-based interaction of a person with the signage device;
acquiring at least one information about the person;
selecting a reward to attribute to the person according to the information;
dispensing the reward to the person.

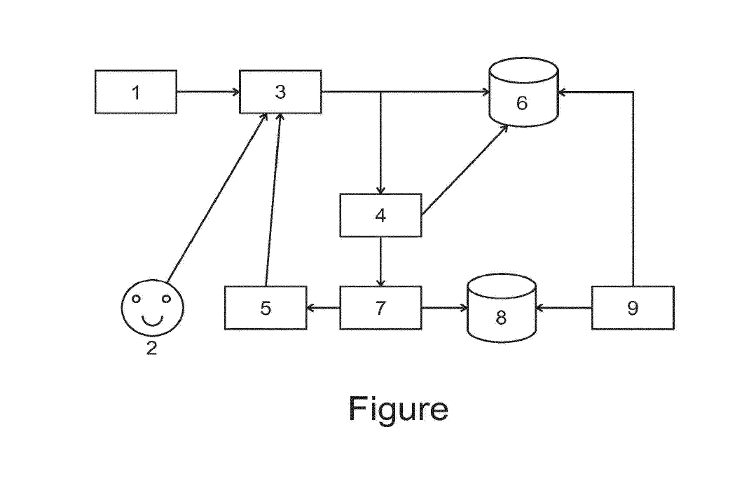

### CROSS-REFERENCE TO RELATED APPLICATION

The present application is the US national phase of International Application No. PCT/EP2014/073844, filed on Nov. 5, 2014. The priority application PCT/EP2014/073844, is hereby incorporated by reference.

The invention relates to a process for rewarding the audience of a signage device, such as a system for implementing such a process.

The signage device can comprise a traditional signage installation, such as a display or a poster, or an electronic signage installation, such as a flat screen or a billboard, wherein advertising messages can be displayed to be viewed by people circulating in the vicinity of said signage device. Moreover, the signage device may be localised in a public space, such as in a store, a boutique, an agency, a lounge, a restaurant, a mall or a transportation hub, wherein a lot of people, and thus a lot of potential customers, can be found.

In the domain of marketing, it is important to identify precisely the potential customers and their habits, so as to provide to said customers reluctant rewards that are well adapted to them. Rewards can notably be promotions, price reductions and/or fidelity points, and can notably be provided to people in the form of paper coupons, promotional messages sent on electronic devices worn by people, such as for example mobile phones, or fidelity points credited on a fidelity account and available through a fidelity card.

To do so, there exists some solutions for monitoring the audience circulating in the vicinity of a signage device, notably video analysis solutions that provide for capturing and analysing images of said audience to obtain information about said audience, such as its size, its general demographic profile and/or its global interest for the signage device. Thus, the acquired information may be used to provide advertising messages that are adapted to the audience, for example by displaying such adapted messages on the signage device.

For example, face detection or face recognition algorithms allows for obtaining easily information about attributes of a person, such as information relating to the age, the gender, the ethnic group, the lifestyle and/or the dress style of said person, such information being very useful for identifying the average profile of the audience interested in an advertising message, and thus for accurately selecting an advertising message to be displayed on an installation according to the audience standing in front of said installation.

There also exist some solutions providing for anonymously detecting people by means of wireless communication with electronic devices worn by said people, for example upon detecting Wi-Fi or Bluetooth equipment implemented in such devices, so as to recognize previously registered customers and to provide rewards to said customers. In particular, if a person has previously downloaded an application on an electronic device, such as for example an application provided by a marketing store, said marketing store can send rewards directly on said electronic device as said person approaches said marketing store.

However, such solutions encounters some problems, as people are generally embarrassed about being monitored, even anonymously. In particular, some people may find unpleasant to systematically receive alerts and/or targeted messages on their electronic devices as they stroll in a marketing place, even if they are not always interested in such marketing communication.

The invention aims to improve the prior art by proposing a solution for more accurately rewarding the audience of a signage device.

For that purpose, and according to a first aspect, the invention relates to a process for rewarding the audience of a signage device, said process providing for:

detecting an interest-based interaction of a person with said signage device;

acquiring at least one information about said person;

selecting a reward to attribute to said person according to said information;

dispensing said reward to said person.

According to a second aspect, the invention relates to a system for rewarding the audience of a signage device, said system comprising:

a detection module comprising means for detecting an interest-based interaction of a person with said signage device;

a characterisation module comprising means for acquiring at least one information about said person;

a reward module comprising means for selecting a reward to attribute to said person according to said information and means for dispensing said reward to said person.

Other aspects and advantages of the invention will become apparent in the following description made with reference to the appended FIGURE, which presents a system for audience rewarding according to an embodiment of the invention.

In relation to this FIGURE, a process for rewarding the audience of a signage device 1, such as a system for implementing such a process, will be described below.

In particular, the signage device 1 can be localised in a public space, such as in a store, wherein a lot of people, and thus a lot of potential customers, can be found. Moreover, the signage device 1 can comprise a traditional signage installation, such as a display or a poster, or an electronic signage installation, such as a flat screen or a billboard, wherein advertising messages can be displayed to be viewed by people circulating in the vicinity of said signage device.

The signage device 1 may be notably an electronic signage installation of any size, notably of a tiny size, such as for example a tablet, or of a mid-size, such as for example a flat screen as those which are commonly installed in marketing stores and which are visible at distances comprised between 2 and 10 meters.

The process provides for detecting an interest-based interaction of a person 2 with the signage device 1. To do so, the system comprises a detection module 3 comprising means for detecting such an interest-based interaction.

Indeed, people circulating in the vicinity of the signage device 1 are not necessarily interested in said signage device, and more precisely in the messages displayed on said signage device. Thus, people who are not interested in the signage device 1 may not really be considered as relevant audience for said signage device, so that it is not relevant to attribute rewards to them.

On the contrary, a person 2 which establishes an interest-based interaction with the signage device 1, i.e. a person 2 which show obvious signs of interest for the signage device 1, for example by moving closer to said signage device, by touching said signage device, by fixing the gaze on said signage device, by smiling or expressing a certain emotion when gazing to said device and/or by standing in front of said signage device for a certain time duration, may certainly be considered as a relevant audience, and it can be particularly advantageous in terms of marketing to reward said person.

Thus, the detection of an interest-based interaction of a person 2 with the signage device 1 may notably relate to the detection of at least one particular sign linked to the behaviour of said person towards said signage device, said sign showing that the person 2 is interested in said signage device.

In particular, the detection of the interest-based interaction may notably be achieved upon physical contact of the person 2 with an interactive device located in the vicinity of the signage device 1.

To do so, the system may comprise such an interactive device which is located in the vicinity of the signage device 1, and the detection module 3 may comprise means for detecting an interest-based interaction of the person 2 upon physical contact of said person with said interactive device.

In particular, when the signage device 1 comprises a digital signage installation, said digital signage installation may comprises interactive sensitive means adapted to react to a physical contact of the person 2, such as for example a tactile screen, and the detection module 3 may be adapted to detect an interest-based interaction of the person 2 upon the reaction of said interactive sensitive means.

The detection of the interaction may also be achieved upon capturing and analysing at least one image of the person 2.

To do so, the system may comprise means, notably cameras and/or video cameras located in the vicinity of the signage device 1, for capturing at least one image of the person 2, and the detection module 3 may comprise means for detecting the interest-based interaction of the person 2 upon analysing said image.

In particular, the detection module 3 can comprise means for previously processing the captured image, so as to detect in said captured image an image of a person 2, such as means for further analysing said detected image of said person to detect an interest-based interaction of said person with the signage device 1.

Moreover, the detection module 3 may be adapted to analyse the image to identify a distinctive sign of the interest of the person 2 for the signage device 1, especially a sign relative to the behaviour of said person towards said signage device. For example, according the position of the gaze of the person 2 relative to the signage device 1 and/or the time during which said gaze is fixed on said signage device, the detection module 3 may be adapted to evaluate the interest of the person 2 for the signage device 1 and thus to detect an interest-based interaction of the person 2 with said signage device if said interest is sufficiently important.

The detection of the interaction may also be achieved upon communication with an electronic device 5 worn by the person 2, for example a mobile communication terminal such as a smartphone or a tablet.

To do so, the system may comprise means, notably wireless communication means such as a Wi-Fi device or a Bluetooth device, for communicating with an electronic device 5 worn by the person 2, the detection module 3 comprising means for detecting the interaction of the person 2 with the signage device 1 upon such a communication.

In particular, as the person 2 is standing in front of the signage device 1, the electronic device 5 worn by said person may continuously communicate with the wireless communication means, and the detection device may be adapted to analyse the time duration of said communication in order to detect an interest-based interaction between the person 2 and the signage device 1 if said time duration is long enough.

Once an interest-based interaction of a person 2 with the signage device 1 has been detected, the process further provides for acquiring at least one information about said person. To do so, the system comprises a characterisation module 4 which comprises means for acquiring such information.

The acquired information about the person 2 can comprise information about the behaviour of said person towards the signage device 1, such as for example the direction of the gaze of said person in relation to said signage device, the time duration during which said gaze is fixed on said signage device, the emotion on the face of said person when gazing to said signage device and/or the time duration during which said person is standing in front of said signage device, or any other types of behavioural reactions showing the interest of the person 2 for the signage device 1.

The acquired information about the person 2 can also comprise information about at least one attribute of said person, such as physical information about the age, the gender, the ethnic group, the lifestyle, the height, the corpulence, the hairstyle and/or the dressing style, but also social information, for example the familial and/or the marital status, which can notably be deduced by evaluating the eventual relationships of the person 2 with other people located near the signage device 1.

Indeed, in the domain of marketing, it is particularly advantageous to get such information about the audience, so as to better identify the main profiles of said audience and to adapt the marketing messages to said profiles. In particular, it may be advantageous to use such information to provide adapted rewards to the audience of the signage device 1.

The acquired information about the person 2 can also comprise information about an electronic device 5 worn by said person, as for example a public identifier (ID) of said electronic device.

Thus, according to the type of information to acquire about the person 2, the process can provide to achieve the acquisition of said information upon physical contact of the person 2 with an interactive device located in the vicinity of the signage device 1, upon capturing and analysing an image of the person 2 and/or upon communication with an electronic device 5 worn by the person 2.

To do so, the characterisation module 4 can comprise means for acquiring information about the person 2 upon physical contact of the person 2 with an interactive device located in the vicinity of the signage device 1, upon capturing and analysing an image of the person 2 and/or upon communication with an electronic device 5 worn by the person 2.

For example, as a camera or a video camera located in the vicinity of the signage device 1 captures at least one image of the person 2, the characterisation module 4 can comprise means for measuring information about the direction of the gaze of the person 2 and/or means for measuring information about the eventual relationships of said person with other people for which images has been captured by the video camera, notably by evaluating the distances and/or mutual interactions between said person and said other people.

For example, the characterisation module 4 can implement image processing algorithms adapted for analysing motion patterns of the person 2 and eventual other people located near the signage device 1, so as to evaluate such direction of gaze and/or mutual relationships, or so as to evaluate the emotion on the face of said person, and thus said module can acquire information about the behaviour of the person 2 towards the signage device 1 and/or information about one least one attribute of said person, notably as regards the social relationships of said person.

Moreover, as the person 2 makes a physical contact with an interactive device located in the vicinity of the signage device 1, for example by touching with a finger a tactile screen equipping said signage device, the characterisation module 4 can comprise means for acquiring further information about said physical contact, for example the zone of said physical contact and the element(s) of the message(s) displayed under said zone at the time of said physical contact, and thus means for deducing precise information about said person and the interest of said person for the signage device 1 through said further information about said physical contact.

Besides, as the person 2 wears an electronic device 5 and is standing in front of the signage device 1, communication means located near said signage device may establish a wireless communication with said electronic device 5, and the characterisation module 4 may comprise means for acquiring information about the person 2 through said communication, such as the identifier of the electronic device 5, but also the time duration of the station of the person 2 and/or the message displayed on the signage device 1 during said station, so as to deduce precise information relative to the interest of the person 2 towards the signage device 1.

The system can also comprise other types of devices, such as for example magnetic meters, pressure sensor mats or infrared sensors, which can also capture data about attributes, such as for example the height and/or the corpulence, and/or the behaviour of the person 2. Moreover, the detection module 3 can comprise means for detecting an interactive interaction of the person 2 and/or the characterisation module 4 can comprise means for acquiring information about said person by means of such data.

Advantageously, the process can further provide for registering the information acquired for the person 2, notably by creating a profile for said person. To do so, in relation to the FIGURE, the system comprises an audience database 6 for registering acquired information about the person 2, notably in the form of an individual profile for said person.

In particular, the process can provide for registering preliminary information about the person 2 upon detection of an interest-based interaction of said person with the signage device 1. To do so, in relation to the FIGURE, the detection module 3 comprises means for creating in the audience database 6 at least one entry for the person 2 upon detection of an interaction between said person and the signage device 1, and the characterisation device 4 comprises means for registering in said entry acquired information about said person, so as to create a profile for said person.

The acquired information can also be completed with context based information, such as for example the time and the date at which said information has been acquired and the geographical location of the signage device 1. Indeed, such context based information are particularly relevant to identify a potential audience, as they allow for example to establish a relationship between typical categories of people and specific geographical locations and day periods, so as to identify the geographical locations and day periods wherein a given category of people is more likely to circulate.

To do so, the system can comprise a clock device adapted for providing the characterisation module 4 with temporal information about the current date and time, such as a geographical data device adapted for providing said module with geographical information about the geographical location of the signage device 1, for example a state, a city or a street. If the signage device 1 is located in a public space, the geographical information can concern the type of said public space, for example a grocery store, an apparel store or a train station, or even the specific location of said signage device within said space, for example a product aisle (for a store) or a ticket counter (for a transportation hub).

Moreover, the characterisation module 4 can comprise means for associating acquired information about the person 2 with such geographical and temporal information, so as to register said acquired information in the audience database 6 along with said associated geographical and temporal information.

Thus, as a profile has been created by the person 2, said person may be identified as a potential customer and information acquired about said person are registered to be possibly used later, as for example for market study purposes.

In particular, the information acquired about the person 2 may be used in the case when said person circulates in the vicinity of the signage device 1 at an ulterior period after a previous interest-based interaction of said person with said signage device, notably to adapt the messages to display on said signage device to said person according to information previously acquired relative to the interests of said person. Furthermore, if the person 2 makes a new interest-based interaction with the signage device 1, notably in response to the adapted message displayed for said person on said signage device, the information already acquired for said person may be used to take said new interest-based interaction into account.

To do so, the process may provide in particular to register in the audience database 6 information acquired about the person 2 during previous interest-based interactions of said person with the signage device 1 as entries about former interest-based actions of said person in relation to the signage device 1. Thus, in the case of a further circulation of the person 2 near the signage device 1, the process may provide to achieve the detection of a further interest-based interaction of the person 2 and/or the acquisition of information about said person upon checking in the audience database 6 entries related to former interest-based actions of said person in relation to said signage device.

More generally, as a person 2 circulates near the signage device 1, the process may provide for detecting an interest-based interaction of said person with said signage device and/or for acquiring information about said person upon checking in the audience database 6 the presence of an entry related to former interest-based action of said person related to said signage device, i.e. upon checking if said person has already made interest-based interaction(s) with said signage and/or if information about said person have already been acquired.

To do so, the detection module 3 may comprises means for detecting an interest-based interaction of a person 2 with the signage device 1 and/or the characterisation module 4 may comprise means for acquiring information about said person upon checking in the audience database 6 the presence of an entry related to former interest-based action of said person in relation to said signage device.

Thus, if a person 2 having an interest-based interaction with the signage device 1 has already a registered profile, the detection module 3 may more easily detect said person and the characterisation module 4 may acquire new information about said person to enrich the profile of said person.

For example, a person 2 with a registered profile may quickly and easily be detected through an electronic device 5 worn by said person, provided that information about said electronic device had been previously acquired and registered during a previous interest-based interaction of the person 2 with the signage device 1.

The process further provides for selecting a reward to attribute to the person 2 according to information acquired for said person, and thus for dispensing said reward to said person. To do so, the system comprises a reward module 7 comprising means for selecting a reward to attribute to the person 2 according to information acquired for said person, such as means for dispensing said reward to said person.

In particular, the system comprises a reward database 8 wherein potential rewards may be registered along with required profile information a person 2 may present for benefiting from said potential rewards, and the reward module 7 is adapted to interact with said database to select a reward to attribute to the person 2 according to acquired information about said person.

Generally speaking, a trademark, a retailer and/or a marketing store may adapt the reward database 8 by defining finely reward attribution policies according to its wishes, and notably according to the main profiles of its potential customers. For example, a trademark specialised in childcare products may target in priority persons 2 who are accompanied by children. Moreover, rewarding policies may be obviously defined according to shopping habits of the potential customers, and notably for rewarding customers proportionally to the importance of the interest said customers show for the trademark, the retailer or the marketing store.

In relation to the FIGURE, the reward module 7 interacts with the characterisation module 4 to obtain acquired information about the person 2, and interacts in the same time with the reward database 8 to select a reward to attribute to said person according to said acquired information.

The reward may take several forms that are well known in the domain of marketing. In particular, the reward may be a price reduction that can be applied immediately or during an ulterior purchase, a promotional offer, fidelity points to be credited on a fidelity account, or any other types of gifts to reward the person 2 for the interest said person shows for a particular trademark, a shop or a store, especially by paying attention to advertising messages displayed on the signage device 1.

The process can notably dispense the reward to the person 2 in an electronic form, for example through an electronic message. In particular, the reward may be sent on an electronic device 5 worn by the person 2.

To do so, the reward module 7 comprises means for dispensing the reward to the person 2 in an electronic form, notably means for sending said electronic reward on an electronic device 5 worn by the person 2. In particular, the reward module 7 may interact with the communication means of the system to send the reward on the electronic device 5 of the person 2.

According to a variant, especially if the person 2 does not wear an electronic device 5 adapted to communicate with the system, the process can also dispense the reward to the person 2 in a material form, for example by printing said reward on a material support, such as a paper coupon or a cardboard piece, said printed material support being delivered to the person 2. For example, the reward may be printed in the shape of a barcode, an alphanumeric code or a simple text message.

To do so, the reward module 7 comprises means for dispensing the reward to the person 2 in a material form, notably means for printing said reward on a material support as described above and means for delivering said printed support on the person 2. In particular, the means for printing and the means for delivering may be located in the vicinity of the signage device 1, so that the person 2 having an interest-based interaction with said signage device may easily and quickly retrieve the reward.

In the above mentioned examples, the reward may be dispensed immediately to the person. According to a variant, the process can provide for dispensing the reward indirectly, notably by sending to the person 2, either in electronic form or in material form, means for collecting the reward, so that the reward will be effectively dispensed to said person as said person uses said collecting means.

To do so, the reward module 7 can comprise means for sending such collecting means to the person 2, and the dispensing means of said reward module may further dispense the reward to said person as said person uses said collecting means.

For example, the reward module 7 can send to the person 2 an electronic message comprising a hypertext link, and the person 2 must click on said hypertext link to launch the dispensing of the reward, notably through the sending by said reward module of another electronic message comprising the effective reward. In the same way, the reward module 7 can deliver to the person 2 a material support on which instructions are printed, and the person 2 must follow these instructions to effectively collect the reward.

For a more accurate rewarding of the audience of the signage device 1, the process may dispense the reward to the person 2 only upon agreement of said person. Thus, the process may provide rewards only to people who are really interested in the signage device 1, which allows not to bother other people, especially by avoiding to vibrate unexpectedly electronic devices of said other people with undesired messages or notifications.

To do so, the reward module 7 comprises means for allowing the person 2 to agree the dispensing of the reward, such as means for dispensing the reward to said person upon said agreement.

In particular, the agreement of the person 2 can be achieved upon registration by said person of an electronic device 5 worn by said person, and the reward module 7 can comprise means for allowing the person 2 to register an electronic device 5 worn by said person to agree the dispensing of the reward to said person.

Moreover, once the person 2 has agreed the dispensing of the reward by registering an electronic device 5, the process can provide for sending said reward directly on the registered electronic device 5, which constitutes a relatively simple and intuitive embodiment. To do so, the reward module 7 may comprise means for sending the reward on an electronic device 5 worn by a person 2 upon registration of said electronic device by said person.

The process can notably provide for alerting the person 2 of the possible dispensing of a reward upon agreement of said person, for example by emitting an alert message for said person by means of the signage device 1 or by other means implemented near said signage device.

To do so, the reward module 7 comprises means for alerting the person 2 of the possible attribution of a reward upon agreement of said person, for example by displaying an alert message for said person on the signage device 1 and/or by emitting such an alert message through other means implemented near said signage device, such as specific displaying means and/or audio means.

In particular, the reward module 7 can emit an alert message for indicating to the person 2 that a reward can be dispensed to said person if said person registers an electronic device 5, notably to receive said reward on said electronic device. For example, the reward module 7 can display on the signage device 1 a message with indications, or even with an interactive sign such as a barcode or a QR (Quick Response) code that the person 2 can capture with dedicated means of the electronic device 5 to register said electronic device and launching the sending of the reward on said electronic device.

According to a variant, the reward module 7 can emit an alert message through interactive means implemented in the signage device 1, such as for example a tactile screen of said signage device, or through interactive means located near said signage device, said message comprising for example an interactive symbol or button that the person 2 can activate by physical contact with said interactive means to agree the dispensing of the reward. For example, upon activation by the person 2 of such an interactive button, the reward module 7 may print the reward on a material support and deliver said printed material support to said person directly in the vicinity of the signage device 1, which constitutes a relatively simple and intuitive embodiment.

Advantageously, if the person 2 has registered an electronic device 5 to receive means for collecting a reward, the system can provide, in the case of an ulterior circulation of said person near the signage device 1, and notably of an ulterior interest-based interaction of said person with said signage device, to send the further dispensed reward directly on said electronic device. Thus, the person 2 does not have to manipulate the electronic device 5 again to receive the rewards, and is not bothered during further purchases.

Moreover, the process can provide for alerting the person 2 of the sending of reward collecting means via the signage device 1 and/or via alerting means implemented in the vicinity of the signage device 1. In particular, the reward module 7 can display on the signage device 1 a specific message for alerting the person 2 that a reward has just been sent on the electronic device 5. Thus, the person 2 does not have to manipulate the electronic device 5 to check the reception of the rewards, and is not bothered during purchases.

The process can further provide for registering the rewards dispensed to the person 2, especially upon agreement of said person for said attribution. To do so, the reward module 7 can comprises means for registering in the reward database 8 the rewards that have been dispensed to the person 2, and especially the rewards that have been accepted by said person. Thus, the process can create an enriched profile for the person 2 with purchase information, for example about the shopping habits of said person.

In particular, the process can provide for registering in the reward database 8 rewards dispensed to the person 2 as entries about former interest-based actions of said person in relation to the signage device 1, and thus can also provide, in the case of an ulterior circulation of the person 2 near the signage device 1, for adapting the messages to be displayed on said signage device according to said dispensed rewards.

More generally, the reward database 8 may be used for market study purposes, for example for evaluating the ratio between the number of people who have been rewarded and the total number of people circulating near the signage device 1, and thus for evaluating the number of people that are effectively interested in the signage device 1, and especially in the messages displayed on said signage device.

Moreover, the process can provide for detecting an interest-based interaction of a person 2 and/or for acquiring information about said person upon checking in the reward database 8 the presence of an entry related to a reward formerly dispensed to said person. Indeed, the fact that a person 2 agrees to receive a reward is an obvious sign of the interest of said person for the signage device 1, and more particularly for the messages displayed on said signage device.

To do so, the detection module 3 can comprise means for detecting an interest-based interaction of a person 2 and/or the characterisation module 4 can comprise means for acquiring information about said person upon checking in the reward database 8 the presence of an entry about to rewards formerly dispensed to said person, for example through direct interaction with said reward database or via the reward module 7.

In particular, the characterisation module 4 can use the entries registered for the person 2 in the reward database 8 to enrich the profile of said person according to rewards already dispensed, and notably accepted by said person. Thus, the reward module 7 can further select rewards that are adapted to the enriched profile, notably by selecting more advantageous rewards for a person 2 which has previously accepted a lot of rewards and thus showed a lot of interest in relation to the signage device 1.

The process can also provide to redeem the reward once the person uses the dispensed reward. To do so, the system comprises a redeem module 9 which comprises means for redeeming the reward once the person 2 uses the dispensed reward.

In particular, if the signage device 1 is located in a store, the redeem device 9 can be implemented within said store, for example in a network for managing cash registers of said store. Thus, when a person 2 makes purchases within the store and wants to benefit from rewards linked to said, for example price reduction for purchased products or credits of fidelity points on the fidelity account of said person, said person can present the reward to a cash register and the redeem module 9 may register the use of said reward by redeeming said reward.

According to variants, the redeem module 9 may be implemented in another environment, for example into the webpage of a trademark, a retailer of said trademark or a marketing store. Thus, as the person 2 uses rewards through online purchases on such a webpage, for example by entering a code during the validation of said purchases, the redeem module 9 may redeem the reward upon said purchase validation.

For redeeming the reward, the redeem module 9 may interact with the reward database 8 for modifying the entries related to rewards formerly dispensed to the person, for example by deleting the entries related to the used reward.

More advantageously, the process can provide for registering the redeeming of the reward as an entry related to former interest-based action of the person 2 in relation to the signage device 1. To do so, the redeem module 9 can comprise means for registering, either in the reward database 8 and/or in the audience database 6, the redeeming of the reward as an entry related to former interest-based action of the person 2 in relation to the signage device 1.

Thus, in the case of a further circulation of the person 2 near the signage device 1, the messages displayed on said signage device can be better adapted to said person according to rewards that have been effectively used by said person.

In particular, the process can provide for detecting an interest-based interaction of a person 2 and/or for acquiring information about said person upon checking in the reward database 8 and/or in the audience database 6 the presence of an entry related to a reward formerly used by said person. Indeed, the fact that a person 2 effectively uses a reward is an obvious sign of the interest of said person for the signage device 1, and more particularly for the messages displayed on said signage device.

To do so, the detection module 3 can comprise means for detecting an interest-based interaction of a person 2 and/or the characterisation module 4 can comprise means for acquiring information about said person upon checking in the reward database 8 and/or in the audience database 6 the presence of an entry about to rewards formerly used by said person, for example through direct interaction with said database(s) or via the reward module 7.

In particular, the characterisation module 4 can use the entries registered for the person 2 in the reward database 8 and/or in the audience database 6 to enrich the profile of said person according to rewards effectively used by said person. Thus, the reward module 7 can further select rewards that are adapted to the enriched profile, notably by selecting more advantageous rewards for a person 2 which has previously used a lot of rewards and thus showed a lot of interest in relation to the signage device 1.

What is claimed is:

1. A process for rewarding the audience of a signage device, said process comprising:
detecting an interest-based interaction of a person with said signage device;
acquiring at least one information about said person;
selecting a reward to attribute to said person according to said information;
dispensing said reward to said person.

2. The process according to claim 1, the acquired information including information about the behavior of the person towards the signage device.

3. The process according claim 1, the acquired information including information about at least one attribute of the person.

4. The process according to claim 1, the detection of the interest-based interaction and/or the acquisition of information being achieved upon physical contact of the person with an interactive device located in the vicinity of the signage device.

5. The process according to claim 1, the detection of the interest-based interaction and/or the acquisition of information being achieved upon capturing and analyzing at least one image of the person.

6. The process according to claim 1, the detection of the interest-based interaction and/or the acquisition of information being achieved upon communication with an electronic device worn by the person.

7. The process according to claim 1, the detection of the interest-based interaction and/or the acquisition of information being achieved upon checking in at least one database the presence of an entry related to former interest-based action of the person in relation to the signage device.

8. The process according to claim 1, the reward being dispensed to the person in an electronic form.

9. The process according to claim 8, the reward being sent on an electronic device worn by the person.

10. The process according to claim 1, the reward being dispensed to the person in a material form.

11. The process according to claim 10, the reward being printed on a material support that is delivered to the person.

12. The process according to claim 1, including sending to the person means for collecting the reward, the reward being dispensed to said person as said person uses said collecting means.

13. The process according to claim 1, the reward is provided to the person upon agreement of said person.

14. The process according to claim 13, the agreement of the person being achieved upon registration by said person of an electronic device worn by said person.

15. The process according to claim 14, the reward being sent on the registered electronic device.

16. The process according to claim 13, including alerting the person of the possible dispensing of a reward upon agreement of said person.

17. The process according to any of claim 1, including redemption of the reward once the person uses the dispensed reward.

18. The process according to claim 7, including registering in the database the redeeming of the reward as an entry related to former interest-based action of the person in relation to the signage device.

19. A system for rewarding the audience of a signage device, said system comprising:
a detection module comprising means for detecting an interest-based interaction of a person with said signage device;
a characterization module comprising means for acquiring at least one information about said person;
a reward module comprising means for selecting a reward to attribute to said person according to said information and means for dispensing said reward to said person.

20. The system according to claim 19, the characterization module comprising means for acquiring information about the behaviour of the person towards the signage device.

21. The system according to claim 19, the characterization module comprising means for acquiring information about at least one attribute of the person.

22. The system according to claim 19, further comprising an interactive device located in a vicinity of the signage device, the detection module comprising means for detecting the interest-based interaction of the person and/or the characterization module comprising means for acquiring information about said person upon physical contact of said person with said interactive device.

23. The system according to claim 19, further comprising means for capturing at least one image of the person, the detection module comprising means for detecting the interest-based interaction of the person and/or the characterization module comprising means for acquiring information about said person upon analyzing said image.

24. The system according to claim 19, further comprising means for communicating with an electronic device worn by the person, the detection module comprising means for detecting the interest-based interaction of the person and/or the characterization module comprising means for acquiring information about said person upon said communication.

25. The system according to claim 19, characterized in that it comprises at least one database comprising entries about former interest-based actions of audience in relation to the signage device, the detection module comprising means for detecting the interest-based interaction of the person and/or the characterisation module comprising means for acquiring information about the person upon checking in said database the presence of such an entry for said person.

26. The system according to claim 19, the reward module comprising means for dispensing the reward to the person in an electronic form.

27. The system according to claim 26, the reward module comprising means for sending the reward on an electronic device worn by the person.

28. The system according to claim 19, the reward module comprising means for dispensing the reward to the person in a material form.

29. The system according to claim 28, the reward module comprising means for printing the reward on a material support and means for delivering said printed material support to the person.

30. The system according to claim 19, the reward module comprising means for sending to the person means for collecting the reward, the dispensing means of said reward module further dispensing the reward to said person as said person uses said collecting means.

31. The system according to claim 19, the reward module comprising means for allowing the person to agree the dispensing of the reward, such as means for dispensing said reward upon said agreement.

32. The system according to claim 31, the reward module comprising means for allowing the person to register an electronic device (5) worn by said person, the agreement of said person being achieved upon said registration.

33. The system according to claim 32, the reward module comprising means for sending the reward on the registered electronic device.

34. The system according to any of claim 31, the reward module comprising means for alerting the person of the possible dispensing of a reward upon agreement of said person.

35. The system according to claim 19, further comprising a redeem module which comprises means for redeeming the reward once the person uses the dispensed reward.

36. The system according to claim 35, the redeem module comprising means for registering in the database the redeeming of the reward as an entry related to former interest-based action of the person in relation to the signage device.
